(19) United States
(12) Patent Application Publication
(10) Pub. No.: US 2024/0235002 A9
(43) Pub. Date: Jul. 11, 2024

(54) MODULAR TOOL-LESS INTERFACE FOR INDUSTRIAL TRANSMITTER

(71) Applicant: Rosemount Inc., Shakopee, MN (US)

(72) Inventors: Greg E. GINDELE, Maple Lake, MN (US); Theodore H. SCHNAARE, New Prague, MN (US); Cory M. ROBINSON, Mayer, MN (US); Ryan C. TARRAS, Savage, MN (US); James A. JOHNSON, Savage, MN (US); Jason H. RUD, Chanhassen, MN (US); Eric R. LOVEGREN, Monticello, MN (US); Hun CHHUOY, Savage, MN (US); Nathan K. HOLM, Mound, MN (US)

(21) Appl. No.: 18/491,133

(22) Filed: Oct. 20, 2023

Related U.S. Application Data
(60) Provisional application No. 63/418,111, filed on Oct. 21, 2022.

(51) Int. Cl. H01Q 1/00; H01Q 1/42

(52) U.S. Cl. CPC H01Q 1/005; H01Q 1/002; H01Q 1/42

(57) ABSTRACT

A modular industrial transmitter includes a communication module and a sensor module. The communication module is configured to communicate with a remote device and has a common interface configured to couple to a plurality of different types of sensor modules. The sensor module is coupled to the common interface of the communication module. Physical coupling of the communication module to the sensor module is performed tool-lessly.

### CROSS-REFERENCE TO RELATED APPLICATION

The present application is based on and claims the benefit of U.S. Provisional Patent Application Ser. No. 63/418,111, filed Oct. 21, 2022, the content of which provisional application is hereby incorporated by reference in its entirety.

### BACKGROUND

Industrial Internet of Things (IIoT) is rapidly developing to provide ease of connected instrumentation for monitoring and control of legacy applications and those that have historically been challenging to access. The density and mobility of instrumentation, application type, differences in regulations, data security, sensitivity and sovereignty, and cost-value trade-offs are among the factors that drive the need for a variety of sensing, actuation, and connectivity protocols. The cost of field sensors and sensor network infrastructure present significant barriers to adoption of IIoT solutions.

Growing IIoT protocol availability, small size, and local power (e.g., an internal battery, energy harvesting from ambient environment, or a closely connected energy solution) is creating opportunities for creative sensing solutions that do not exist today due to the cost of making the measurement and transporting the data.

### SUMMARY

A modular industrial transmitter includes a communication module and a sensor module. The communication module is configured to communicate with a remote device and has a common interface configured to couple to a plurality of different types of sensor modules. The sensor module is coupled to the common interface of the communication module. Physical coupling of the communication module to the sensor module is performed tool-lessly.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view of example interchangeable assembly modules for a modular HOT industrial transmitter architecture in accordance with an embodiment of the present invention.

FIG. 2 is a block diagram of a given sensor module coupled to a given communication module through a common digital interface in accordance with an embodiment of the present invention.

FIG. 3 is a diagrammatic view of a mechanical assembly and how it could be combined In accordance with embodiments of the present invention.

FIG. 4 is an exploded diagrammatic view of a communication module being coupled to a sensor module in accordance with an embodiment of the present invention.

FIG. 5 is a diagrammatic view of a communication module coupled to a sensor module in accordance with an embodiment of the present invention.

FIG. 6 is a diagrammatic perspective exploded view of a communication module coupling to a sensor module in accordance with an embodiment of the present invention.

### DETAILED DESCRIPTION OF ILLUSTRATIVE EMBODIMENTS

Industrial Internet of Things (IIoT) adoption is rapidly increasing, creating opportunities for a new class of easy-to-use connected measurement and control instrumentation. These opportunities exist for both legacy measurement applications and for new asset optimization and health monitoring that will help end users run their operations in more efficient, reliable, sustainable, and environmentally friendly ways. To satisfy the diverse demands of IIoT users, a variety of measurement, control and connectivity solutions are needed depending on the application. To efficiently support a growing IIoT business and rapidly evolving end user requirements, a modular measurement and control platform approach is provided to adapt new communication modules easily and quickly to various transducers and actuators that share a common physical and electrical interface.

Using a modular approach, a variety of assemblies with a communication protocol output can be quickly attached to another variety of assemblies that perform an action relative to a process application, such as measurement or actuation. This scheme allows for improved design efficiency by developing fully approved and tested communication and sensor module components. The components can be combined in a number of ways to provide rapid transmitter solutions where users require a specific protocol to be available for a sensing technique.

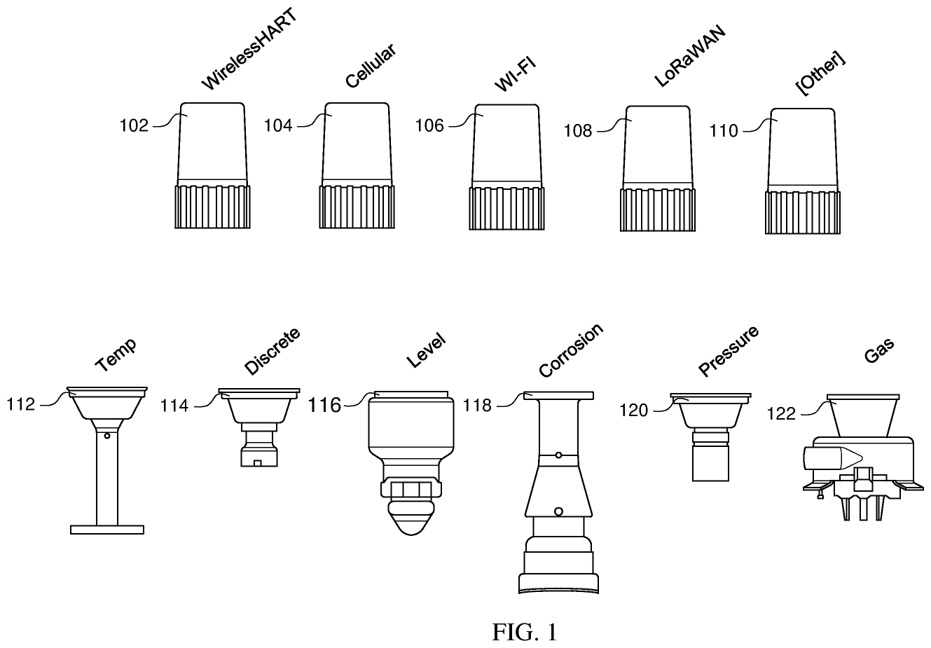

FIG. 1 is a diagrammatic view of example interchangeable assembly modules for a modular IIOT industrial transmitter architecture in accordance with an embodiment of the present invention. The architecture includes a number of communication modules 102, 104, 106, 108, and 110 that are couplable to any one of the various measurement or actuation devices 112, 114, 116, 118, 120, and 122. The coupling of a given communication module to a given measurement or actuation device creates a fully functional system.

In the embodiment shown in FIG. 1, a number of communication modules are shown. Communication module 102 is configured to couple to any of the measurement or actuation modules 112, 114, 116, 118, 120, and 122. Communication module 102 is configured to communicate in accordance with the WirelessHART process communication protocol (IEC62591). Communication module 104 is configured to couple to any of the measurement or actuation modules 112, 114, 116, 118, 120, and 122. Communication module 104 is configured to communicate in accordance with a cellular communication protocol. Suitable examples of cellular communication protocols include, without limitation, GPRS, UMTS, CDMA2000, LTE, LTE-M, NB-IOT, WiMax, 5G NR, and other protocols now used or later developed for cellular telephone networks. Communication module 106 is configured to couple to any of the measurement or actuation modules 112, 114, 116, 118, 120, and 122. Communication module 106 is configured to communicate in accordance with a WiFi standard. Suitable examples of WiFi standards include: IEEE 802.11 b/g/n/a/ac/ax/be. Communication module 108 is configured to couple to any of the measurement or actuation modules 112, 114, 116, 118, 120, and 122. Communication module 108 is configured to communicate in accordance with a LoRaWAN protocol (ITU-T Y.4480). Communication module 110 is configured to couple to any of the measurement or actuation modules 112, 114, 116, 118, 120, and 122. Communication module 110 is configured to communicate in accordance with another suitable communication protocol (such as Bluetooth Low Energy) or any other protocol now known or later developed. Additionally, while various wireless communication protocols have been disclosed, it is also contemplated that communication may be wired communication instead of or in addition to wireless communication. Suitable examples of wired communication protocols include, without limitation, HART®, FOUNDATION Fieldbus, Profibus—PA, et cetera.

In the embodiment shown in FIG. 1, a number of measurements or actuation devices are shown. Temperature measurement module 112 is configured to couple to any of the communication modules 102, 104, 106, 108, and 110. Temperature measurement 112 module also includes or is configured to couple to one or more temperature sensors to measure an electrical characteristic (e.g., emf, resistance, impedance, et cetera) of the one or more temperature sensors that is indicative of a temperature. Suitable examples of temperature sensors include, without limitation, resistance temperature devices (RTD), thermocouples, thermistors, and infrared sensors.

Discrete I/O module 114 is configured to couple to any of the communication modules 102, 104, 106, 108, and 110. Discrete I/O module 114 includes a number of discrete input or output channels. These channels may be digital, analog, or a combination thereof. As can be appreciated, when a communication module is coupled to discrete I/O module 114, communication with the assembly can allow a remote device to effect a change by causing a discrete analog and/or digital output on module 114. Similarly, individual signals such as digital signals or analog signals can be coupled to input channels of discrete I/O module 114 to allow a remote device to observe the status and/or magnitude of such signals.

Level module 116 is configured to couple to any of the communication modules 102, 104, 106, 108, and 110. Level module 116 is configured to measure a level of a product in a container or conduit. In one example, level module 116 is configured to transmit microwave energy into the container and receive a reflection back that is indicative of one or more interfaces occurring at detected distances from level module 116, where the detected distance(s) correspond to level of one or more products within the container.

Corrosion detection module 118 is configured to couple to any of the communication modules 102, 104, 106, 108, and 110. Corrosion detection module 118 is configured to detect corrosion of a structure or surface to which module 118 is coupled. In one example, corrosion detection module 118 is configured to mount to a pipe for which corrosion detection is desired and periodically, or on demand, perform a corrosion detection test using any suitable technique including launching an ultrasonic signal into the pipe and comparing the response with a response obtained from an initial, non-corroded state.

Pressure detection module 120 is configured to couple to any of the communication modules 102, 104, 106, 108, and 110. Pressure detection module 120 is configured to couple to a source of process fluid pressure (e.g., a pipe or conduit) and detect the pressure of the process fluid within the conduit. Pressure detection module 120 may include or be coupled to one or more pressure sensors that have an electrical characteristic (e.g., resistance or capacitance) that varies with applied pressure. Additionally, pressure detection module 120 may include a plurality of pressure sensors where each pressure sensor is fluidically coupled to an opposite side of a flow restriction in the process fluid conduit. In this way, pressure detection module 120 may also provide an indication of process fluid flow based on the difference in pressure detected across the flow restriction. In some examples, the pressure sensor may be a non-intrusive pressure sensor.

Gas detection module 122 is configured to couple to any of the communication modules 102, 104, 106, 108, and 110. Gas detection module 122 is configured to detect one or more gases of interest and provide an electrical indication thereof. Gas detection module includes one or more gas sensors that have an electrical signal or property that changes in response to exposure to a gas of interest, such as combustible, flammable and/or toxic gases. Gas sensors may include infrared point sensors, ultrasonic sensors, electrochemical gas sensors and semiconductor sensors.

In accordance with some embodiments described herein, the individual modules are separately subject to an approvals process and approved for their respective industrial function such that an assembly of an approved communication module and approved measurement/actuator module is also approved. An example of an important approval for industrial devices is: APPROVAL STANDARD INTRINSICALLY SAFE APPARATUS AND ASSOCIATED APPARATUS FOR USE IN CLASS 1, 11 and III, DIVISION NUMBER 1 HAZARDOUS (CLASSIFIED) LOCATIONS, CLASS NUMBER 3610, promulgated by Factory Mutual Research October, 1998. Another example of an important approval for industrial devices is an ATEX certification to Ex-d standards EN60079-0 and EN60079-1 for potentially explosive atmospheres.

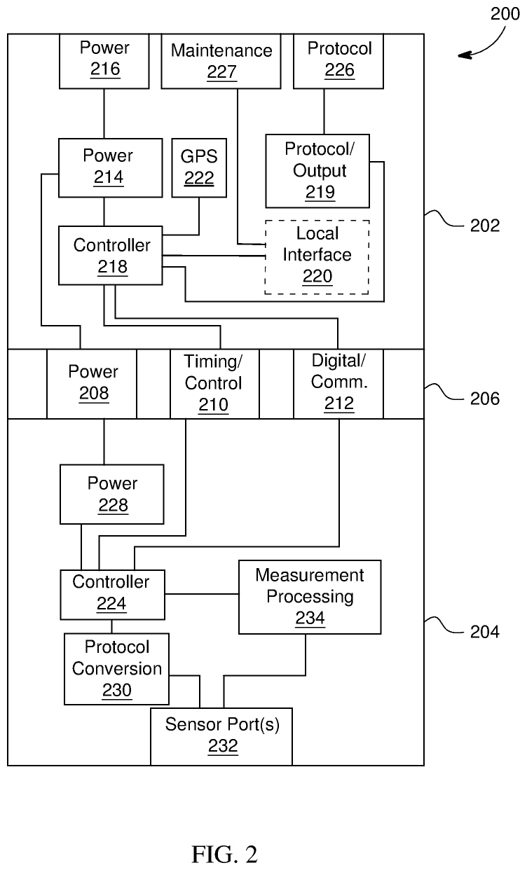

FIG. 2 is a block diagram of a given sensor module coupled to a given communication module through a common digital interface in accordance with an embodiment of the present invention. FIG. 2 shows a transmitter solution 200 formed by the coupling of communication module 202 to sensor module 204 via interface 206. Interface 206 is a common interface to all communication and measurement (i.e., sensor) and actuation modules. Common interface 206 includes a number of connections at set locations such that any module can expect a given connector to be at the location set in the common interface. Examples of various connectors includes power connections/signals 208, timing/control connections/signals 210, and digital communication connections/signals 212. The modules have a common interface to allow for interchangeability between various sensor modules and communication modules. FIG. 2 highlights interface 206 and functions each module will typically manage. In the illustrated embodiment, interface 206 is made up of three general groups of signals 208, 210, and 212 with some being optional. The digital communication interface 212 is a bi-directional port between modules 202 and 204 allowing for data transfers and general system management. Time syncing and clock sharing are provided with the timing/control signals 210 for systems that depend on time critical functions. Regulated voltage along with a direct connection to power module 214 is available to sensor module 204 via power connection/signals 208. The direct connection can be used for sensor modules with high power demands or specific voltage regulation needs. It will also be available for voltage monitoring for battery operated assemblies during activities of sensor module 204. Power connections/signals 208 may also be galvanically isolated to provide isolation between power and other externally connected inputs.

Interface 206 generally supports the exchange of duty cycle and task timing information between the sensor module and the communication module to allow for a variety of sensing and/or actuation applications that require different lengths of time to stabilize and/or execute.

Generally, communication module 202 is the primary controller of all functions that relate to the output protocol and configuration porting. Communication module 202 includes power module 214. In one embodiment, power module 214 includes a local power source, such as an internal battery (fixed or rechargeable) and suitable regulation circuitry to provide power to other components of communication module 202. In one embodiment, power module 214 includes an intrinsically-safe power source that can be installed in a volatile ambient environment. In other embodiments, power module 214 may simply contain suitable power regulation circuitry to suitably condition power received from power module port 216 for provision to other components of communication module 202. Power may be provided to power module port 216 from an external source such as an external thermoelectric generator; vibrational power scavenger; wind generator; solar cell, et cetera. Additionally, power module 214 may include circuitry to monitor power levels on any external power sources to determine when to charge an internal storage, such as a rechargeable battery or capacitor, and when to use power directly from the external power source or internal storage.

Communication module 202 also includes controller 218 coupled to power module 214, protocol/output circuitry 219, and optional local interface 220 and GPS module 222. Controller 218 is also coupled to timing/control connections 210 and digital communication connections 212 which allow controller 218 to interact with controller 224 of sensor module 204. Controller 218 may be any suitable circuitry that is able to execute a number of programmatic steps or functions to interact with sensor module 204 and communicate with an external device using protocol/output circuitry 219. Controller 218 may be an application specific integrated circuit (ASIC), field programmable gate array (FPGA), microcontroller, or microprocessor. Controller 218 is configured, through hardware, software, or a combination thereof, to detect the coupling of a sensor module via interface 206 and interact with a connected sensor module to determine the capabilities and/or requirements of the connected sensor module and choose appropriate communication for the connected sensor module (e.g., selecting appropriate units/range/precision et cetera). Thus, controller 218 is configured to authenticate the connected sensor module, recognize approved combinations, and link with sensor module 204 to form the transmitter solution Once communication module 202 has identified the connected sensor module 204 and modified its operation for the connected sensor module, a complete transmitter solution is complete. An indication of this status can be provided by communicating via the protocol/output circuitry, engaging a local indicator, such as an LED, or both.

As shown in FIG. 2, communication module 202 may include a GPS sensor 222 that is coupled to controller 218. In this way, communication module 202 can geographic location information regarding its position and transmit such position to a remote device. This is particularly useful for long range, remote installations or mobile applications. Further, GPS sensor 222 may also be used for tracking.

FIG. 2 also illustrates controller 218 coupled to protocol/output circuitry 219. This circuitry allows controller 218 to communicate in accordance with one or more standard protocols. Examples of wireless communication protocols include, without limitation, WirelessHART, Cellular (NB-IoT, LTE-M), Wi-Fi, LoRaWAN, and Bluetooth Low Energy. Additionally, as shown in FIG. 2, protocol/output circuitry 219 may be coupled to a protocol port 226 that is configured to coupled to a wired connection. Examples of such wired communication include, without limitation, HART, 4-20 mA, FOUNDATION′ Fieldbus, Profibus, Modbus, Ethernet, and Ethernet-APL. When communication module 202 is not coupled to any sensor module, communication module 202 can still function as a communication repeater, such as a standalone wireless repeater. Additionally, in embodiments where the communication module includes multiple protocol circuits, it may function as a wireless gateway. For example, communication module 202 may receive HART signals via a wired connection and transmit them wirelessly using a suitable wireless communication protocol, such as WirelessHART.

In some embodiments, communication module 202 may include local interface logic 220 that is coupled to controller 218 and facilitates local interaction with communication module 202. In some examples, this may include a local display such as an LCD or LED display, one or more status LEDs, and/or one or more operator inputs, such as a button or knob. The status LEDs can be used to provide a simple visual indication of certain device status information including, without limitation, battery health, sensor assembly health, communication module health, sensor connection status/health, network connection status/health, et cetera. Additionally, the status LED(s) can be in the form of multicolor LEDs such that a certain color is indicative of a certain condition. Additionally, or alternatively, the status LED(s) can flash in accordance with pre-defined flash codes in order to convey various messages or conditions.

In other examples, the local interface logic 220 is coupled to maintenance port 227 which allows a local user to configure and calibrate both communication module 202 and sensor module 204. Maintenance port 227 can employ a wired connection and/or a wireless connection to a handheld communicator. In examples where the connection from maintenance port 227 the handheld communicator is wireless, such communication can be Bluetooth or Near Field Communication (NFC). Additionally, local interface logic 220 may provide one or more of its functions via an internal webserver that interacts with an external device, such as a handheld communicator or smartphone, via maintenance port 227.

Sensor module 204 is generally the primary controller for all functions related to sensor measurement and processing of the output value(s). Sensor module 204 will require time for task completion (i.e., obtaining a measurement from a sensor and processing the measurement). Additional time could be required for sensors needing multiple measurements or longer voltage stabilization to produce a valid measurement. Since sensor module is aware (e.g., during manufacture of a particular sensor module it is known what type of sensor will be coupled to the sensor module and how many measurements and how much voltage stabilization is required) of its task time requirements, a latency management scheme is employed by sensor module controller 224 to allow for task completion for a variety of sensor modules. Sensor module 204 can preemptively wake up to prepare and complete its appropriate task before communication module 202 requests an update.

Sensor module 204 includes power management circuitry 228 that is coupled to power connections 208 and provides regulated power to components of sensor module 204. Power management circuitry 228 may also include one or more direct connection lines that can be used in specific sensor module implementations. The direct connection can be used for sensor modules with higher power demands or specific voltage regulation needs. Additionally, power management circuitry 228 can also provide voltage monitoring for battery-operated assemblies during sensor module activities.

Sensor module 204 also includes protocol conversion circuitry 230 coupled to controller 224. Protocol conversion circuitry 230 is configured to allow adaptation of sensors with digital outputs, such as Modbus to interface with communications module 202. As shown, protocol conversion module is coupled to one or more sensor ports 232 to receive such digital sensor output(s). In some process actuation embodiments, protocol conversion circuitry may include one or more digital-to-analog converters that enable controller 224 to generate an analog output voltage or signal. Additionally, or alternatively, protocol conversion circuitry 230 may include suitable switches to generate one or more digital outputs.

Sensor module 204 also includes measurement processing circuitry 234 coupled to sensor port(s) 232 and controller 224. Measurement processing circuitry 234 includes suitable circuitry for measuring an analog electrical characteristic (e.g., resistance, voltage, current, et cetera) and providing a digital indication of the measured analog electrical characteristic to controller 224. Suitable examples of circuitry of measurement processing circuitry includes one or more analog-to-digital converters, one or more amplifiers, and or one or more multiplexers or switches. As such, measurement processing circuitry 234 provides generic sensing of one or more discrete signals to indicate state of an external interface. Further, measurement processing circuitry 234 provides generic sensing of current and/or voltage for any number of applications such as battery monitoring and diagnostic calculations of external power banks. Any suitable type of sensor can be coupled to sensor port(s) 232 including, without limitation, temperature sensors, pressure sensors, level sensors, corrosion sensors, gas detection sensors, or any combination thereof.

Sensor module 204 can, in some cases, be a legacy wired or wireless process variable transmitter with a digital port to interact with communication module 202. The legacy transmitter (i.e., sensor module) may continue to participate on its intended communication port, but also with the connected communication module 202. For example, a HART/4-20 mA process variable transmitter can continue to produce a wired HART/4-20 mA output, but also provide data to communication module 202 with a different output protocol.

While embodiments described above generally couple a single sensor module with a single communication module, it is expressly contemplated that a single sensor module may be coupled to a plurality of different communication modules. In such case, the single sensor module can provide a measurement to multiple communication modules to provide an output through a number of communication paths. For example, a sensor module can interact with a WirelessHART communication module for local clustering and also interact with a Cellular communication module for distance monitoring. Another example is providing a data point into two or more WirelessHART networks through one transmitter solution. Additionally, it is expressly contemplated that sensor module 204 may aggregate multiple measurements to a single communication module 202.

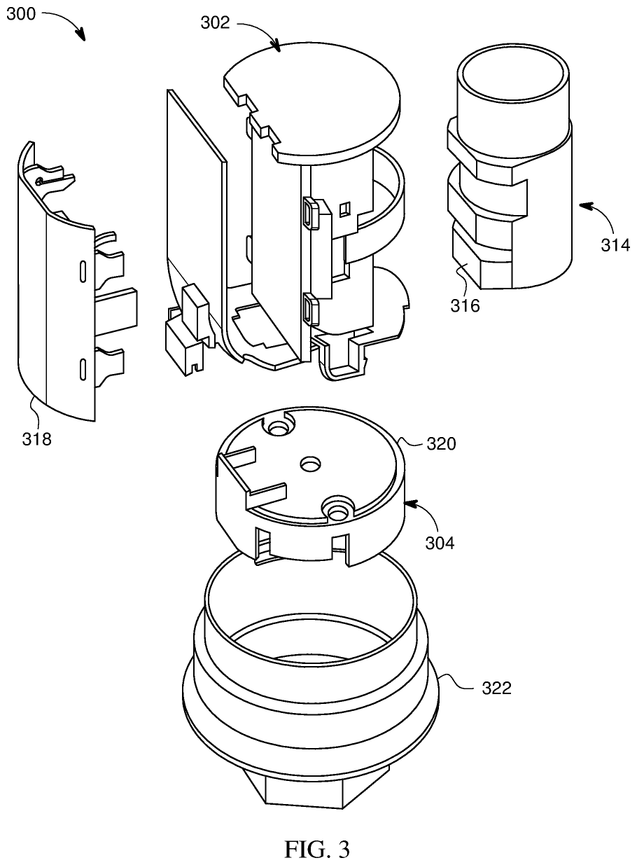

FIG. 3 is an exploded diagrammatic view of a mechanical assembly and how it could be combined in accordance with embodiments of the present invention. Assembly 300 includes communication module 302 and sensor module 304. Communication module 302 includes a power module 314 that may include a battery, such as a D-cell battery. Power module 314 is inserted into communication module 302 with various power connections 316 shown near a bottom portion of power module 314. Housing 318 is also coupled to communication module 302. Communication module 302 includes a number of connectors on a bottom surface thereof which couple to corresponding connectors on sensor module 304. Sensor module 304 includes sensor module electronics 320 which is configured to couple to connectors of communication module 302 and to fit within sensor module housing 322.

The common interface employed in accordance with embodiments described herein can take various forms. In one example, the interface includes a tool-less, poka-yoke mechanical and electrical interface between the communication module and the sensor module. Additionally, the common interface can include a keying feature such that the communication module may only be coupled to the sensor module in a single rotational orientation. Additionally, the common interface can include one or more snap features that allow the modules to mechanically snap together. Preferably, the communication module and the sensor module can be coupled together electrically and mechanically without requiring any tools. The power module may also be held securely within the communication module with one or more snap features or another suitable simple retention mechanism that does not require any tools for battery replacement. The mechanical design of the interface helps ensure that only compatible, authentic communication and sensor modules may be coupled together. This tool-less and modular approach allows for easy installation, quick battery replacement and/or quick and easy electronics access without needing to remove the sensing module.

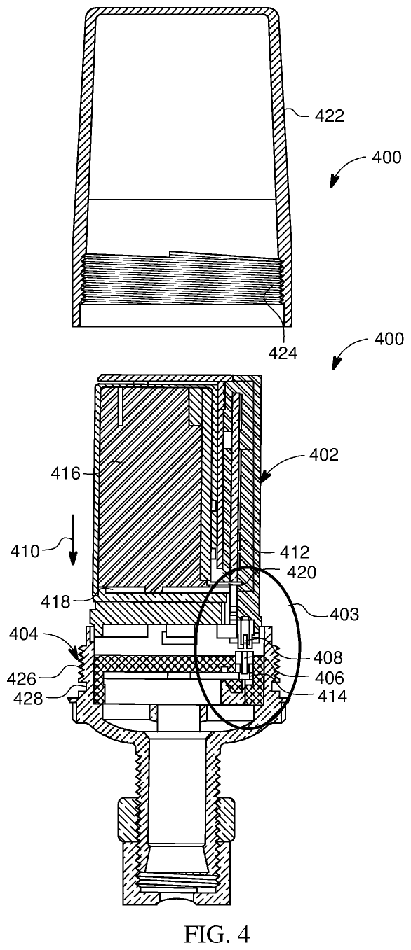

FIG. 4 is an exploded diagrammatic view of a communication module being coupled to a sensor module in accordance with an embodiment of the present invention. As shown, communication 402 is being coupled to sensor module 404. In the area of circle 403, pins 406 of sensor module 404 are spaced slightly below receptacles 408 of communication module 402 and communication module 402 is moved in the direction indicated by arrow 410. Receptacles 408 may be mounted directly to a circuit board 412 of communication module 402 or spaced remotely therefrom. Similarly, pins 406 of sensor module 404 may be mounted directly to circuit board 414 or spaced remotely therefrom. As can be seen in FIG. 4, power module 416 comprises a battery as well as a circuit board 418 that includes a plurality of connectors 420 that connect to corresponding connectors on circuit board 412 when power module 416 is installed into communication module 402. Once communication module 402 is coupled to sensor module 404, cover 422 is installed by threading internal threads 424 onto external threads 426 of sensor module 404. Additionally, sensor module includes an annular groove 428 to receive and maintain an elastomeric O-ring (not shown) that helps create an environmental seal when cover 422 is installed.

While the various chassis components of the communication module and/or sensor module can be constructed from any suitable materials, it is preferred that the chassis of the communication module be formed of a polymeric material. Additionally, it is preferred that the chassis of the sensor module be formed of a material robust enough to be mounted to a process and contain or be coupled to a sensor. In some examples, the chassis of sensor module 404 may be formed of a metal. In some examples, it is also preferred that the polymeric chassis of the communication module include one or more features, such as snap features, that engage with corresponding features of the sensor module to allow for simple, tool-less coupling of the communication module to the sensor module. It is preferred that the snap features maintain both mechanical and electrical contact between the communication module and the sensor module.

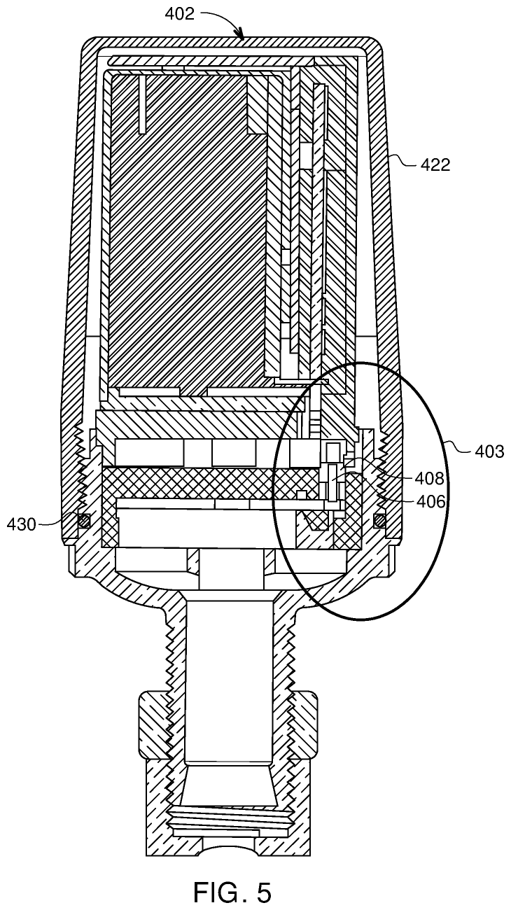

FIG. 5 is a diagrammatic view of a communication module coupled to a sensor module in accordance with an embodiment of the present invention. As can be seen, receptacles 408 of communication module 402 are now fully engaged with pins 406 of sensor module thereby electrically coupling the communication module with the sensor module. Additionally, cover 422 is installed and O-ring 430 seals the electronics of the communication module and the sensor module from the ambient environment.

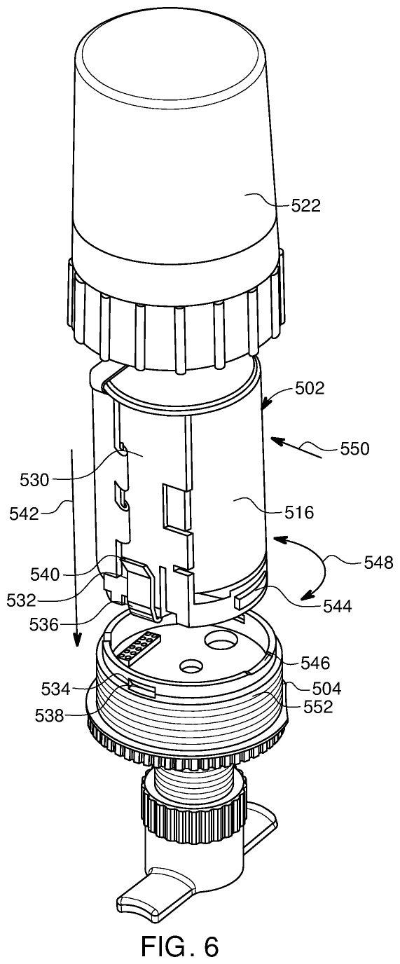

FIG. 6 is a diagrammatic perspective exploded view of a communication module coupling to a sensor module in accordance with an embodiment of the present invention. Communication module 502 includes a polymeric chassis 530 that includes one or more snap features 532 that engage corresponding features 534 on sensor module 504. As can be seen, snap feature 532 is generally in the form of a U-shaped clip having a barb 536 that engages an aperture 538 of feature 534 when communication module 502 is moved sufficiently in the direction of arrow 542. Snap feature 532 also includes tab 540 that is configured to be squeezed inwardly in order to release the engagement of barb 536 with aperture 538 when communication module 502 needs to be decoupled from sensor module 504. Preferably, an identical snap feature is located on the opposite side of communication module 502, such that the pair of snap features fully retain communication module 502 and sensor module 504 together. FIG. 6 also shows communication module 502 having a key 544 that may only engage slot 546 of sensor module 504 when communication module 502 is rotated in the direction of arrow 548 to the correct rotational orientation.

When it is necessary to change the power module of communication module 502, power module 516 may simply be slid out from polymeric chassis 530 and a new power module 516 can be slid into chassis in the direction of arrow 550. When the replacement power module is coupled to polymeric chassis 530 and communication module 502 is coupled to sensor module 504, cover 522 is installed by threading cover 522 onto external threads 552 of sensor module 504.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

Although the present invention has been described with reference to preferred embodiments, workers skilled in the art will recognize that changes may be made in form and detail without departing from the spirit and scope of the invention. In various aspects, an assembly, interface, communication module, sensor module, maintenance port and status indications are provided for use with modular assemblies.

What is claimed is:

1. A modular industrial transmitter comprising:
a communication module configured to communicate with a remote device, the communication module having a common interface configured to couple to a plurality of different types of sensor modules;
a sensor module coupled to the common interface of the communication module; and
wherein physical coupling of the communication module to the sensor module is performed tool-lessly.

2. The modular industrial transmitter of claim 1, wherein the sensor module includes a common interface configured to couple to a plurality of different types of communication modules.

3. The modular industrial transmitter of claim 1, wherein the communication module and the sensor module include keying features configured to allow coupling of the communication module and the sensor module in a single rotational orientation.

4. The modular industrial transmitter of claim 3, wherein the keying features are configured to only allow valid combinations of communication modules and sensor modules to be coupled together.

5. The modular industrial transmitter of claim 3, wherein physically coupling the communication module to the sensor module is done in a single axial movement without any rotation.

6. The modular industrial transmitter of claim 1, wherein the communication module contains a connector mounted to a first printed circuit board, and the sensor module contains a connector mounted to a second printed circuit board, and coupling the communication module to the sensor module couples the connector of the communication module to the connector of the sensor module.

7. The modular industrial transmitter of claim 1, wherein a connection between the communication module and the sensor module is a poka-yoke connection.

8. The modular industrial transmitter of claim 1, wherein the communication module includes a replaceable battery that is insertable into a chassis of the communication module.

9. The modular industrial transmitter of claim 1, wherein the chassis is formed of a polymer.

10. The modular industrial transmitter of claim 1, wherein the communication module is configured to engage the sensor module with at least one snap connection.

11. The modular industrial transmitter of claim 10, wherein at least one snap connection includes a plurality of snap connections located on opposite sides of the communication module.

12. The modular industrial transmitter of claim 10, wherein at least one snap connection includes a tab that is configured to be squeezed to release a barb of the snap connection from an aperture of the sensor module.

13. The modular industrial transmitter of claim 1, and further comprising a cover configured to cover the communication module and mount to the sensor module.

14. The modular industrial transmitter of claim 13, wherein the cover seals the communication module and the sensor module from ambient environment.

15. The modular industrial transmitter of claim 1, wherein the communication module and the sensor module are configured to communicate bi-directionally when coupled.

16. The modular industrial transmitter of claim 15, wherein the communication module and the sensor module are configured to authenticate one another.

17. The modular industrial transmitter of claim 1, wherein physically coupling the communication module to the sensor module occurs in a volatile industrial environment.

18. The modular industrial transmitter of claim 1, wherein circuitry of at least one of the communication modules and the sensor module is intrinsically safe.
